(19) United States
(12) Patent Application Publication
(10) Pub. No.: US 2008/0175783 A1
(43) Pub. Date: Jul. 24, 2008

(54) Amino-Functionalized Mesoporous Silica

(75) Inventors: Sang-Eon Park, Inchon (KR); Sujandi Sujandi, Inchon (KR); Dae-Soo Han, Inchon (KR); Seung-Cheol Lee, Inchon (KR)

Correspondence Address: THE WEBB LAW FIRM, P.C., 700 KOPPERS BUILDING, 436 SEVENTH AVENUE, PITTSBURGH, PA, 15219, US

(73) Assignee: Inha-Industry Partnership Institute of Inha University, Inchon (KR)

(21) Appl. No.: 11/852,680

(22) Filed: Sep. 10, 2007

(30) Foreign Application Priority Data
Jan. 22, 2007 (KR) 10-2007-0006438

(51) Int. Cl. C01B 33/12

(52) U.S. Cl. 423/335; 204/157.43

(57) ABSTRACT

The present invention relates to amino-functionalized mesoporous silica. The present invention provides amino-functionalized mesoporous silica having hexagonal platelet morphology with short channels perpendicular to the platelet. The lengths of the channels are preferably 10˜1000 nm. The present invention also provides a method for preparing amino-functionalized mesoporous silica having hexagonal platelet morphology comprising a series of steps in sequence which are reactive gel preparation before subjected to the microwave, microwave heating for co-condensation reaction and crystallization, and solvent extraction for surfactant removal. The direct co-condensation approach with microwave heating and adoption of sodium metasilicate as silica source can give great advantage in the view of economy and environment.

### BACKGROUND OF THE INVENTION

The present invention relates to amino-functionalized mesoporous silica.

Since the preparation of mesoporous silica based on micelle templates of surfactants, there have been numerous reports on the applications of these materials to chemical, biological, optical, and electronic industries, more specifically, to catalysis, separation, sensors and drug delivery. Many of recent studies have been focused on incorporation of organic functionality through inorganic-organic hybridization and/or by control of pore morphology or structure.

Their morphology and functionalization may be important factors in enhancing applicabilities. The preparation of organo-functionalized mesoporous materials should be made under control of morphology for utilizing mesoporous structure. The overall morphology is as important as the internal structure of mesoporous silica for certain applications. The mesoscopic structure, mesopore channel orientation, and macroscopic morphology of mesoporous silica could affect the overall diffusion and mass transfer of substrates. In addition, the functionalization could introduce active site on the amorphous mesoporous silica's wall.

Silica having hexagonal platelet morphologies with short hexagonal mesopore channels perpendicular to the platelet are particularly useful for the fabrication of thin film for developing separation membranes and photonics technologies since short channels can facilitate rapid diffusion and mass transfer of substrates into and out of the mesopores.

Purely silicious SBA-15 materials with different well-defined morphologies have been synthesized by addition of co-surfactants, additives, or co-solvents during synthesis. On the other hand, addition of organosilanes during direct synthesis of organo-functionalized SBA-15 mesoporous materials in strongly acidic conditions mostly did not result in textural morphologies mentioned above but in fibrous morphologies having long channels which have handicaps of poor accessibility, slow diffusion and slow mass transfer.

Chen et al (B.-C. Chen, H.-P. Lin, M.-C. Chao, C.-Y. Mou, C.-Y. Tang, Adv. Mater., 2004, 16, No. 8, 1657-1661) reported preparation of pure siliceous mesoporous material having platelet morphology with short channel perpendicular to the platelet by using a cationic-anionic-nonionic ternary surfactant system.

Zhang et a] (H. Zhang, J. Sun, D. Ma, X. Bao, A. Klein-Hoffmann, G. Weinberg, D. Su, R. Schlogi, J. Am. Chem. Soc., 2004, 126, 7440-7441) prepared mesoporous silica with short channel by using large excess of decane as a co-solvent. However, the morphology and particle size of those materials are not uniform.

Chen et al (U.S. Pat. No. 20050244322 (2005)) also prepared mesoporous silica with perpendicular-arrayed channels by using calcium carbonate nanoparticle as template. The prepared mesoporous materials have overall morphology of hollow or thin-shell type structure. Potential advantages such as easy accessibility, rapid diffusion and favorable mass transfer was recognized with the mesoporous silica with submicrometer short channels.

Sun et al reported that SBA-15 particle with nanoscale pore length has potential applications to fast separation of biomolecules and that enzyme adsorption speed and amount are faster and larger respectively than those of conventional mesoporous silica.

Researches for introducing functionality either by incorporating organic moiety onto the silica surface or metallic species into the silica framework have been actively carried out since the surface of amorphous silica is inert in catalysis and adsorption. Generally, there are two methods widely adopted for functionalization, i.e., a direct co-condensation method and a post-grafting method. The direct co-condensation method is more plausible because it might avoid several shortcomings in the post-grafting method such as reduction of pore sizes, pore blocking at the aperture and difficulties in controlled loadings and distributions of the active sites (A. S. M. Chong, X. S. Zhoa, J. Phys. Chem. B 107 (2003) 12650).

Among the variety of organo-functionalized mesoporous materials synthesized through the direct synthesis route, amino-functionalized mesoporous materials have received considerable attentions in recent years. Macquarrie and coworker (D. J. Macquarrie, D. B. Jackson, Chem. Commun., 1997 1781) adopted mesoporous silica with amino group immobilized onto as a catalyst for base-catalyzed condensation reactions. Balas et al (F. Balas, M. Manzano, P. Horcajada, M. Vallet-Regi, J. Am. Chem. Soc., 2006, 128, 8116-8117) showed that mesoporous silica surface with amino group immobilized onto is an active site for delivery of bisphosphonates drug and for its controlled release into the bone tissue. Amino-functionalized mesoporous silica is also useful as a support for enzyme immobilization. Enzyme immobilization onto a support enables easy separation and reuse of enzymes, and thus reduce the process cost. In addition, the immobilized enzymes are stable in a harsh reaction medium.

Traditionally, amino-functionalized mesoporous silica has been prepared by reaction of mesoporous silica with organosilanes, which is called ‘post grafting method’. However, the final material by this method, likely consists of multiple types of amines. Some are isolated amines but the majorities are hydrogen-bonded to each other. To create truly well-defined functionalized site in the materials, functionalized amine should be isolated (U.S. Pat. No. 6,380,266 (2002)).

Notesteind and coworker (J. M. Notestein, A. Katz, Chem. Eur. J., 2006, 12, 3954-3965) observed that the amino-functionalized silica with isolated amine group show a 90-fold enhancement in turnover rate over the conventional amino-functionalized silica with multiple type amine groups.

As mentioned above, the direct co-condensation synthesis method is widely adopted for the synthesis of mesoporous silica with spatially dispersed functional groups. However, it was presumed that aminopropyltriethoxysilane would have strong adverse effect for preparing ordered mesoporous silica (A. S. M. Chong, X. S. Zhoa, J. Phys. Chem. B 107 (2003) 12650).

Wang et al (X. Wang, K. S. K. Lin, J. C. C. Chan, S. Cheng, J. Phys. Chem. B 2005, 109, 1763-1769) prepared amino-functionalized silica by the direct co-condensation method with prehydrolysis of silica source for certain time prior to the addition of aminopropyltriethoxysilane. However, the amino groups are less likely to distribute homogenously into the mesopore since silica mesostructure has basically formed during the prehydrolysis period. Mehdi et al (A. Mehdi, C. Reyé, S. Brandès, R. Guilard, R. J. P. Corriu, New J. Chem., 2005, 29, 965) used protected aminopropyltriethoxysilane in order to overcome the strong adverse effect and the obtained material still lacks orderness. In addition, several time-consuming steps should be added.

Recently, microwave synthesis method for preparing nanoporous materials has been developed. The shortening of preparation time to tens of minutes to hours instead of days (which are usually required for the conventional hydrothermal method) is the obvious advantages of this method. Moreover, the rapid and homogeneous heating throughout the reaction vessel, homogeneous nucleation and rapid crystallization and phase selectivity allow the facile control of particle size and morphology (for examples see U.S. Pat. No. 20010054549 (2001); KR. Pat. No. 10200500811559 (2005)). More recently, Park group, inventors of the present invention (Sujandi, S.-E. Park, D.-S. Han, S.-C. Han, M. J. Jin, T. Ohsuna, Chem. Commun., 2006, 4131; Sujandi, S.-C. Han, D.-S. Han, S.-E. Park, Stud. Surf. Science and Catal., 2006, accepted) has combined the advantages of the microwave synthesis and the direct co-condensation method for the synthesis of functionalized mesoporous silica materials in order to achieve highly dispersed and isolated active sites. The present invention is in line with the article.

### SUMMARY OF THE INVENTION

It is one purpose of the present invention to provide mesoporous silica having excellent catalytic activity as well as high diffusion and mass transfer rate.

It is another purpose of the present invention to provide a method for preparing amino-functionalized mesoporous silica having short vertical channels economically.

The present invention provides amino-functionalized mesoporous silica having hexagonal platelet morphology with short channels perpendicular to the platelet.

The present invention also provides a method for preparing amino-functionalized mesoporous silica having hexagonal platelet morphology comprising a series of steps in sequence which are reactive gel preparation before subjected to the microwave, microwave heating for co-condensation reaction and crystallization, and solvent extraction for surfactant removal.

The direct co-condensation approach with microwave heating in the present invention can give great advantage in the view of economic and environment. The successful adoption of sodium metasilicate as silica source is also cost effective. The short channels and the amino groups highly dispersed and pendant to the silica surface in the present invention exhibit excellent catalytic activity and effectiveness.

### BRIEF DESCRIPTION F THE DRAWING

FIG. 1 shows SEM and TEM images of the amino-functionalized mesoporous silica with 200-300 nm channels length prepared in Example 1.

FIG. 2 shows SEM and TEM images of the amino-functionalized mesoporous silica with about 150 nm channels length prepared in Example 2.

FIG. 3 shows SEM and TEM images of the amino-functionalized mesoporous silica with 100-150 nm channels length prepared in Example 3.

FIG. 4 through 6 show respectively SEM images of the amino-functionalized mesoporous silica prepared in Examples 4 through 6.

FIG. 7 shows SEM and TEM images of traditional amino-functionalized silica with fibrous type morphology.

### DETAILED DESCRIPTION OF THE INVENTION

The present invention provides amino-functionalized mesoporous silica having hexagonal platelet morphology with short channels perpendicular to the platelet. The lengths of the channels are preferably 10˜1000 nm.

As one embodiment, the present invention provides amino-functionalized mesoporous silica having hexagonal platelet morphology with short channels perpendicular to the platelet, wherein the lengths of the channels are 200˜500 nm.

As another embodiment, the present invention provides amino-functionalized mesoporous silica having hexagonal platelet morphology with short channels perpendicular to the platelet, wherein the lengths of the channels are 150˜200 nm.

As another embodiment, the present invention provides amino-functionalized mesoporous silica having hexagonal platelet morphology with short channels perpendicular to the platelet, wherein the lengths of the channels are 10˜150 nm.

The mesoporous silica is preferably prepared by co-condensation of aminoalkyltriethoxysilane and silica in the molar ratio 0.01˜0.5 of aminoalkyltriethoxysilane to silica based on surfactant templates under microwave radiation. The silica is more preferably sodium silicate, most preferably sodium metasilicate. The surfactant is more preferably tri-bloc-oxides, i.e., polyethylene oxide-polypropylene oxide-polyethylene oxide which is on the market as P123. The aminoalkyltriethoxysilane is preferably aminopropyltriethoxysilane.

The present invention also provides a method for preparing amino-functionalized mesoporous silica having hexagonal platelet morphology comprising a series of steps in sequence which are reactive gel preparation before subjected to the microwave, microwave heating for co-condensation reaction and crystallization, and solvent extraction for surfactant removal.

The present invention provides more preferably a method for preparing amino-functionalized mesoporous silica having hexagonal platelet morphology comprising
i) mixing tri-bloc surfactant, aminoalkyltriethoxysilane and sodium silicate in the molar ratio 0.01˜0.5 of aminoalkyltriethoxysilane to sodium silicate in a solvent;
ii) acidifying the mixture by adding acid to the mixture;
iii) heating the mixture under microwave radiation; and
iv) cleaning and drying the mixture crystallized

The mixture in the step ii) is preferably stirred at room temperature during and after acidifying. The surfactant is tri-bloc-oxides, i.e., polyethylene oxide-polypropylene oxide-polyethylene oxide which is on the market as P123. The aminoalkyltriethoxysilane is preferably aminopropyltriethoxysilane.

The amino-functionalized mesoporous silica according to the present invention is of wide hexagonal shape and small thickness different from the commonly fibrous morphologies of SBA-15 as shown in FIG. 7. The perpendicular pore channels are much shorter than those of fibrous type SBA-15.

The microwave heating is adopted for stimulating co-condensation reaction between aminoalkylsilanes and silica and at the same time for aging to crystallization of the amino-functionalized mesoporous silica. The microwave heating facilitates the co-condensation reaction and shortens aging time needed for getting highly crystalline mesoporous silica from more than 1 day to hours (Y. K. Hwang, J.-C. Chang, S.-E. Park, D. S. Kim, Y.-U. Kwon, S. H. Jhung, J.-S. Hwang, M. S. Park, Angew. Chem., Int. Ed., 2005, 117, 562; Y. K. Hwang, J.-S. Chang, Y.-U. Kwon, S.-E. Park, Micro. Meso. Mater., 2004, 68, 21.).

The direct co-condensation approach with microwave heating in the present invention can give great advantage in the view of economy and environment. The successful adoption of sodium metasilicate as silica source is also cost effective. The short channels and the amino groups highly dispersed and pendant to the silica surface in the present invention exhibit excellent catalytic activity as seen in the base catalyzed reactions. Short channels perpendicular to the platelet morphology could make diffusion and mass transfer of substrate easier into and out of the pore channel.

Preparations and characterizations of amino-functionalized mesoporous silica according to the present invention are exemplified hereinafter with images obtained by spectroscopy techniques such as scanning electron microscope, transmission electron microscope, and UV-Vis-NIR. Applications to base catalyzed condensation reactions are also explained in detail.

### EXAMPLE 1

Preparation of Amino-Functionalized Silica Having 0.05 Molar Ratio of Amine to Silica

16 g of 10% (w/w) aqueous solutions of P123 were poured into 26.6 g distilled water and then 4.32 g of sodium silicate and 0.18 g of aminopropyltriethoxysilane were added to the reaction mixtures. The mixtures were vigorously stirred, preferably by using mechanical stirrers, at room temperature until homogenous solutions were obtained. The vigorously stirred solutions were acidified with concentrated hydrochloric acid to the acid concentration 2 M. The final mixtures were stirred for 2 hour at 40° C. then subjected to microwave heating for co-condensation reaction and crystallization as following. The reactive gel was filled into Omni Teflon vessel and subjected to microwave irradiation. The microwave condition for co-condensation reaction and crystallization was set under a static condition at 100° C. for 2 h with operating power of 300 W (100%). The crystallized products were filtered, washed with warm distilled water and ethanol and finally dried. The surfactant can be removed by using solvent extraction, preferably by using ethanol, to obtain surfactant-free amino-functionalized silica.

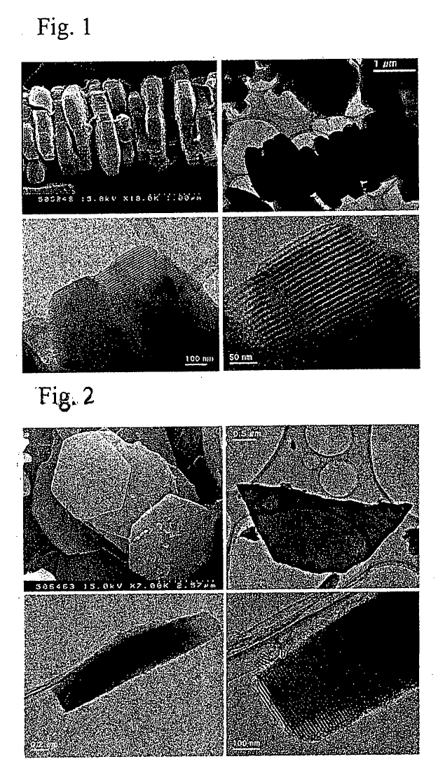

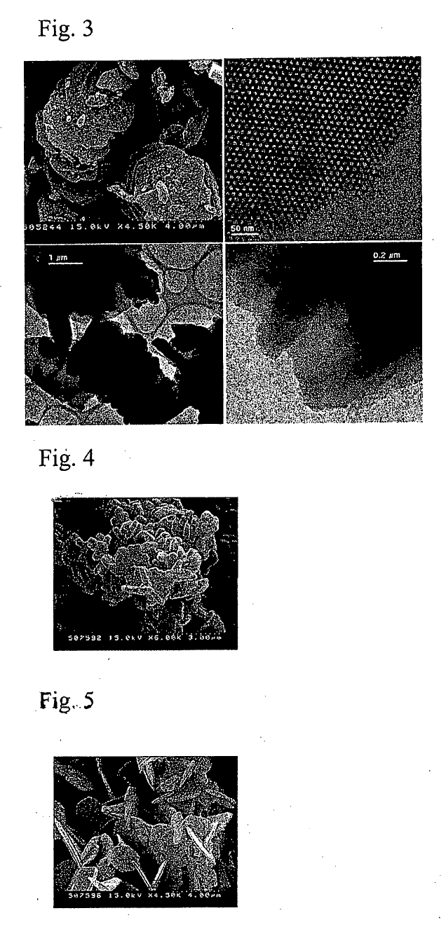

The SEM and TEM analysis reveal that the material has short mesopore at the range of 200-300 nm as FIG. 1. The crystal shape is a thick hexagonal platelet (hexagonal prism). This material has BET surface area of 761 square meters per gram, pore volume of 1.01 centimeter cubic per gram and pore size of 9.8 nanometers by the nitrogen adsorption-desorption analysis based on Barrett, Joyner and Halenda method. The material has incorporated amino group equal to 0.99 millimole per gram reveal as CNHS elemental analysis.

### EXAMPLE 2

Preparation of Amino-Functionalized Silica Having 0.075 Molar Ratio of Amine to Silica

Example 2 is carried out in the same way as Example 1 except that 4.21 g of sodium silicate and 0.27 g of aminopropyltriethoxysilane instead of 4.32 g of sodium silicate and 0.18 g of aminopropyltriethoxysilane were added to the reaction mixtures.

The SEM and TEM analysis reveal that the material has short mesopore at the range of 150 nm as FIG. 2. The crystal shape is a medium thick hexagonal platelet (hexagonal disk). This material has BET surface area of 733 square meters per gram, pore volume of 1.22 centimeter cubic per gram and pore size of 10.8 nanometers by the nitrogen adsorption-desorption analysis based on Barrett, Joyner and Halenda method. The material has incorporated amino group equal to 1.17 millimole per gram as revealed by CNHS elemental analysis.

### EXAMPLE 3

Preparation of Amino-Functionalized Silica Having 0.1 Molar Ratio of Amine to Silica

Example 3 is carried out in the same way as Example 1 except that 4.09 g of sodium silicate and 0.35 g of aminopropyltriethoxysilane instead of 4.32 g of sodium silicate and 0.18 g of aminopropyltriethoxysilane were added to the reaction mixtures.

The SEM and TEM analysis reveal that the material has short mesopore at the range of 100˜150 nm as FIG. 2. The crystal shape is a thin hexagonal platelet (hexagonal chip). This material has BET surface area of 680 square meters per gram, pore volume of 0.94 centimeter cubic per gram and pore size of 9.0 nanometers by the nitrogen adsorption-desorption analysis based on Barrett, Joyner and Halenda method. The material has incorporated amino group equal to 1.34 millimole per gram as revealed by CNHS elemental analysis.

### EXAMPLE 4˜6

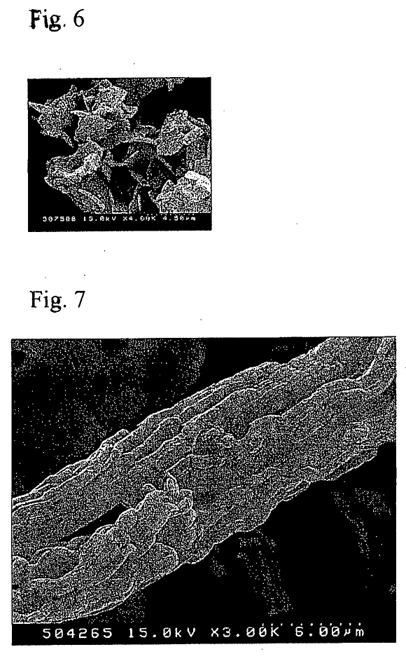

Example 4 through 6 are carried out in the same way respectively as Example 1 through 3 except that the vigorously stirred solutions were acidified with concentrated hydrochloric acid and then, without stirring, directly subjected to microwave heating. The SEM analysis for the silica prepared in Example 4 through 6 is shown respectively by FIG. 4, FIG. 5 and FIG. 6. revealing that the amino-functionalized SBA-15 materials prepared in these examples have wider hexagonal plates.

### EXAMPLE 7

Catalytic Activity of Amino-Functionalized SBA-15 With Hexagonal Disk-Like Morphology in Base Catalyzed Condensation Reaction

The catalytic activities of the amino-functionalized SBA-15 having nanoscale short channel with hexagonal disk-like morphology as prepared in Example 2 for Knoevenagal condensation between benzaldehyde and ethyl cyanoacetate was investigates at 303 K with toluene as solvent. In typical catalytic reaction, a mixture of 50 mg catalyst, x mmol benzaldehyde, x mmol ethyl cyanoacetate (with x=1.5; 3; 6; and 12) and 1 ml toluene was introduced into the reaction vessel and heated at 303 K with constant stirring. Small amount of reaction mixture was frequently removed from the reaction vessel and subsequently the reaction products were analyzed by gas chromatography with dodecane as an internal standard. The yields are calculated from the following equation and plotted in Table 1.

Yield (%)=100×{(Initial concentration of banzaldehyde or ethyl cyanoacetate−final concentration of banzaldehyde or ethyl cyanoacetate)/Initial concentration of banzaldehyde or ethyl cyanoacetate}

Table 1

Time-course of the Knoevenagel condensation of benzaldehyde (1) with ethyl cyanoacetate (2)

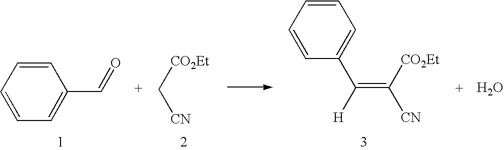

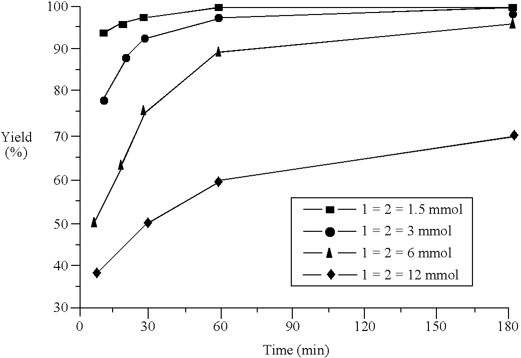

1. Amino-functionalized mesoporous silica having hexagonal platelet morphology with short channels perpendicular to the platelet.

2. A mesoporous silica according to claim 1, wherein the mesoporous silica is prepared by co-condensation of aminoalkyltriethoxysilane and sodium silicate in the molar ratio 0.01˜0.5 of aminoalkyltriethoxysilane to sodium silicate based on surfactant templates under microwave radiation and the lengths of the channels are 10˜1000 nm.

3. Mesoporous silica according to claim 2, wherein the surfactant is P123.

4. Mesoporous silica according to claim 3, wherein the aminoalkyltriethoxysilane is aminopropyltriethoxysilane.

5. A mesoporous silica according to claim 2, wherein the lengths of the channels are 200˜500 nm.

6. A mesoporous silica according to claim 2, wherein the lengths of the channels are 150˜200 nm.

7. A mesoporous silica according to claim 2, wherein the lengths of the channels are 10˜150 nm.

8. A mesoporous silica according to claim 4, wherein the mesoporous silica is used as catalyst in base catalyzed condensation reaction.

9. A method for preparing amino-functionalized mesoporous silica having hexagonal platelet morphology comprising
i) mixing tri-block surfactant P123, aminoalkyltriethoxysilane and sodium silicate in the molar ratio 0.01˜0.5 of aminoalkyltriethoxysilane to sodium silicate in a solvent;
ii) acidifying the mixture by adding acid to the mixture;
iii) heating the mixture under microwave radiation; and
iv) cleaning and drying the mixture crystallized.

10. A method for preparing amino-functionalized mesoporous silica having hexagonal platelet morphology according to claim 9, wherein the aminoalkyltriethoxysilane is aminopropyltriethoxysilane.

11. A method for preparing amino-functionalized mesoporous silica having hexagonal platelet morphology according to claim 9, wherein the mixture is stirred at room temperature during and after acidifying in the step ii).
